(19) United States
(12) Patent Application Publication
(10) Pub. No.: US 2010/0148698 A1
(43) Pub. Date: Jun. 17, 2010

(54) AUDIO CONTROLLED LED DECORATION LAMP STRING SYSTEM

(76) Inventor: CHIH-CHIN YANG, Chupei City (TW)

Correspondence Address: LEONG C LEI, PMB # 1008, 1867 YGNACIO VALLEY ROAD, WALNUT CREEK, CA, 94598, US

(21) Appl. No.: 12/335,547

(22) Filed: Dec. 16, 2008

(51) Int. Cl. H05B 37/02

(52) U.S. Cl. 315/297

(57) ABSTRACT

The present invention is an audio controlled LED decoration lamp string system that mainly is to design a system with flashing function by inputting the audio source's frequency to directly control the LED decoration lamp string and create the variation of light and shade. The said system can be electrically-conducted in from a first sector capable of providing the AC (alternate current) or DC (direct current) power to a second sector's IC and electrically-conducted in a fifth sector's LED lamp string simultaneously. And, the second sector's IC is separately electrically-conducted with a third sector's MIC (audio source receiver) and a fourth sector's PWM (pulse width modulation). The fourth sector's PWM is then electrically conducted with a fifth sector's LED lamp string to form a complete system.

### BACKGROUND OF THE INVENTION

The known LED decoration lamp string capable of creating flashing effect mainly uses a build-in typed control switch to control the whole string of LED lamp string by the specific intermittent lighting-on of non equal numbers of lamps. This kind of flashing is a kind of fixed mode. Therefore, the flashing form created by the whole LED lamp string is stereotypical consistent and unable to achieve a more vigorous and touching flashing effect that varies according to the varying music. It thus is not ideal and waited to be improved.

### SUMMARY OF THE INVENTION

The major object of the present invention is to provide an audio controlled LED decoration lamp string system that can automatically control the lighting and shading brightness of whole LED decoration lamp string through the magnitude of audio source frequency or amplitude to create a more vigorous and touching flashing effect after the whole LED decoration lamp string is power conducted and lightened and after a audio source receiver (MIC) is utilized to receive the nearby or specific audio source then processed by the integrated circuit (IC) and PWM (pulse width modulation). Now, the structures and characteristics are described as following by cooperating with the diagram . . . .

### BRIEF DESCRIPTION OF THE DRAWINGS

FIG. 1 is a system diagram of the present invention.

### DETAILED DESCRIPTION OF THE PREFERRED EMBODIMENT

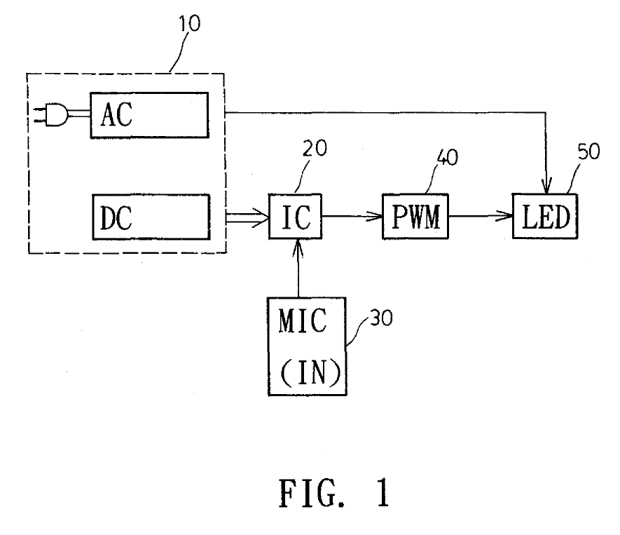

Please refer to FIG. 1. The present invention is an audio controlled LED decoration lamp string system that mainly is aimed at the serial linked or parallel linked LED decoration lamp string to design a system with flashing function by inputting the audio source's frequency to directly control the LED decoration lamp string and create the variation of light and shade. The whole system is including five operating sectors that is electrically-conducted in from a first sector 10 capable of providing the AC (alternate current) or DC (direct current) power to a second sector's IC 20 and electrically-conducted in a fifth sector's LED lamp string 50 simultaneously, and the second sector's IC 20 is separately electrically-conducted with a third sector's MIC (audio source receiver) 30 and a fourth sector's PWM (pulse width modulation) 40, then the fourth sector's PWM 40 is electrically conducted with a fifth sector's LED lamp string 50 to form a complete system.

The way of operation is to open the power of first sector 10 and conduct in the fifth sector 50 to light on the whole LED lamp string to fully bright status and the power is conducted in the second sector 20 simultaneously. At this time, the third sector 30's MIC and fourth sector 40's PWM are also activated at the same time. And, the third sector 30's MIC is utilized to receive the nearby or specific audio sources then transfer them to the second sector 20's IC. Then, after processed by the fourth sector 40's PWM (pulse width modulation), the signals are automatically output to the fifth sector 50 to control the whole decoration lamp string to create the variation of lighting and shading brightness according to the magnitude of audio source and the whole LED decoration lamp string is able to automatically create a more vigorous and touching flashing effect along with the change of environments through this. This design is deeply equipped with the practicability and conforms to the conditions of patents. We thus file the application according to the law.

However, the about mentioned embodiment is only exemplary and is not to limit the scope of the invention. Any modification with the same merit will be still claimed in the present invention.

I claim:

1. An audio controlled LED decoration lamp string system including five operating sectors that is electrically-conducted in from a first sector capable of providing the AC (alternate current) or DC (direct current) power to a second sector's IC and electrically-conducted in a fifth sector's LED lamp string simultaneously, and the second sector's IC is separately electrically-conducted with a third sector's MIC (audio source receiver) and a fourth sector's PWM (pulse width modulation), then is electrically conducted in and controls a fifth sector's LED lamp string through the fourth sector's PWM to form a complete system.
